(19) United States
(12) Patent Application Publication
(10) Pub. No.: US 2004/0178064 A1
(43) Pub. Date: Sep. 16, 2004

(54) Ball supports and puller for pulling a cable through a pipe

(76) Inventor: Thomas A. Lorincz, Hollister, CA (US)

Correspondence Address: HENNEMAN & SAUNDERS, 714 WEST MICHIGAN AVENUE, THREE RIVERS, MI, 49093, US

(21) Appl. No.: 10/389,240

(22) Filed: Mar. 14, 2003

(51) Int. Cl. B23H 3/00

(52) U.S. Cl. 204/297.01

(57) ABSTRACT

A pipe electrochemical polishing system (10) for in place polishing of a pipe (12) has a cathode puller cable (16) having a plurality of balls (34, 34a) distributed along the length of the cable (16). The balls (34, 34a, 34b) support the cable (16) within the pipe (12) and provide rigidity to the cable (16) so that the cable (16) can be pushed through the pipe (12) rather than having to be initially pulled therethrough. The cable (16) can be readily pulled through the pipe (12), and particularly around bends therein, because the balls (34, 34a, 34b) prevent the cable (16) from binding and coming into contact with the interior walls of the pipe (12).

### TECHNICAL FIELD

The present invention relates to the field of electrochemical processing, and more particularly to an apparatus and method for providing for longer pulls, including a greater number of turns, when pulling an apparatus through a pipe by a cable, or the like. The predominant current usage of the present inventive improved pipe electropolishing apparatus and method is for the in place polishing of pipes used in fluid and liquid chemical processing facilities.

### BACKGROUND ART

It is known in the art to deposit and/or remove materials by passing an electric current through a fluid electrolyte which is in contact with a conductive electrode. Materials are exchanged between the electrolyte and the electrode depending upon the direction of current flow and the ionization of materials to be deposited on or removed from the electrode. Electroplating is a well known application of this general method. Electropolishing is also well known in the art. In the electropolishing process, irregularities and deposits on a surface are removed by causing material on the surface to be drawn into the electrolyte solution.

An example of an electropolishing process is the in place electrochemical polishing of the inner surface of a pipe. In this process, a cathode is drawn through the pipe by a cable while an electrolyte solution is simultaneously pumped through the pipe. The pipe acts as an anode and is electrochemically polished in the process. Since the electrolyte solution must be continuously pumped through the pipe during the process, it is most practical to recirculate the solution.

A piping system will generally consist of straight sections of pipe and of bent sections joining such straight sections. According to prior art methods, it has been quite difficult to pull the cable through the pipe, particularly where the length of pipe is long, and even more particularly when the cable must traverse a great number of bends or turns. For example, prior art systems have been able to negotiate a maximum of approximately seven right angle bends. Even when limiting the number of bends and also limiting the length of pipe to be traversed, it has been quite difficult to pull the cable through the pipe, often stalling the motor used to do the pulling.

Another problem with conventional cable pulling systems is that it is very difficult to thread the cable through the pipe in the first place. Devices such as a pull tape are pushed through a section of the pipe, the cable is attached to the tape and then pulled through. This initial insertion operation is so difficult and time consuming that it frequently takes more time than all of the rest of an in place pipe electropolishing process combined.

It would be advantageous to have a method or apparatus for pulling a cable through a pipe which would allow the cable to pull more easily through the pipe, such that a longer length of pipe and/or more bends could be traversed. It would further be advantageous to have some method or apparatus whereby the threading of a cable through a pipe could be made easier. However, to the inventor's knowledge, no such method or apparatus to accomplish either of these purposes has existed in the prior art.

### SUMMARY

Accordingly, it is an object of the present invention to provide an apparatus and method for causing a cable to pull more easily through a pipe.

It is another object of the present invention to provide an apparatus and method for allowing a cable to more easily traverse bends in a pipe.

It is yet another object of the present invention to provide an apparatus and method for easily threading a cable through a pipe.

It is still another object of the present invention to provide an apparatus and method for improving an in place pipe electropolishing process.

Briefly, a known embodiment of the present invention has a plurality of balls generally evenly spaced along the length of a cable. In this embodiment, the cable is affixed to the ball at the center of the ball. As the cable is pulled through a pipe, the balls suspend the cable in the pipe such that the cable generally does not come into contact with the walls of the pipe. Since the balls are made from a low friction material, the balls allow the cable to be easily pulled through the pipe. In pipe bends, wherein the cable has previously been pressed against an inside bend of the pipe corner, the balls also tend to hold the cable away from the pipe and prevent this source of additional drag.

The balls are spaced on the cable such that the cable can be fed through the pipe without the aid of a separate puller tape or cable. That is, the cable, with balls attached, is fed through the pipe in a first direction prior to the commencement of a polishing operation. Then, electrical current is provided to begin the pipe electropolishing operation and the cable is pulled through the pipe generally in the direction opposite to the first direction.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible objects or advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the above described objects and advantages. Accordingly, the listed objects and/or advantages are not essential elements of the present invention, and should not be construed as limitations.

### BRIEF DESCRIPTION OF THE DRAWINGS

FIG. 1 is block diagrammatic view of an example of an in place pipe electropolishing system, according to one example of the present invention;

FIG. 2 is an exploded front elevational view of an example of a ball, according to the present invention;

FIG. 3 is a side elevational view of the ball of FIG. 2;

FIG. 4 is a cross sectional front elevational view of another example of a ball, according to the present invention;

FIG. 5 is a cross sectional side elevational view of another example of a ball, according to the present invention;

FIG. 6 is a front elevational view of the example of the ball of FIG. 5; and

FIG. 7 is a diagrammatic top plan view of an example of the cable puller of FIG. 1.

### DETAILED DESCRIPTION OF THE INVENTION

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

Unless otherwise stated herein, component parts of the invention will be familiar to one skilled in the art, and may be purchased or readily manufactured accordingly. Also, unless otherwise stated herein, substitutions can be made for the components described, and each of the individual components, except as specifically claimed, is not an essential element of the invention.

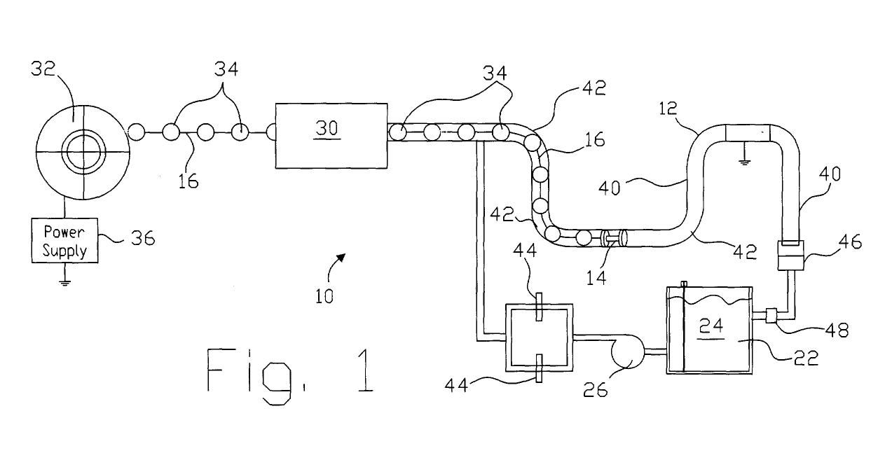

A known mode for carrying out the invention is an in place pipe electrochemical polishing system 10 for polishing the inner surface of a pipe 12. While the invention is illustrated in this example as an “in place” system, wherein the inner surface of the pipe 12 is polished without removing it from its usual place, one skilled in the art will recognize that the invention could be adapted for use in other locations. The in place pipe electrochemical polishing system 10 is depicted in a block schematic diagrammatic view in FIG. 1. As one skilled in the art will recognize, some of the component parts of the in place pipe electrochemical polishing system 10 are a cathode 14, a cathode puller cable 16, an electrolyte reservoir 22 for containing a supply of an electrolyte 24, and an electrolyte pump 26, all of which are provided for the purpose of polishing the interior of the pipe 12.

An inventive cable puller 30 differs from conventional devices as will be discussed in greater detail hereinafter. A cable take up apparatus 32 coils the cable 16 as the cable 16 is drawn out of the pipe 12 by the cable puller 30. As can be seen in the view of FIG. 1, a plurality of balls 34 are generally evenly spaced along at least a portion of the length of the cable 16. In the example shown in the view of FIG. 1, the balls 34 are separated on the cable 16 by approximately the diameter of the balls 34 which, for purposes of this example only, is approximately three inches. One skilled in the art will recognize, in light of this present disclosure, that the diameter of the balls 34 and the relative spacing thereof on the cable 16 will be adaptable to the specific application, most particularly to the diameter of the pipe 12 to be electropolished and other variables such as the inherent stiffness of the cable 16, and the like.

In the electrochemical polishing process, the cathode 14 is drawn toward the cable puller 30 by the cathode puller cable 16, while electrical current is applied through the cathode 14 from a power supply 36. The current flows through the electrolyte 24 in the pipe 12, which shares a common ground with the power supply 36, such that the pipe 12 acts as an anode and the interior thereof is polished according to the known principles of electropolishing. During the process, the electrolyte 24 is generally pumped to flow through the pipe 12 in a direction opposite that in which the cathode 14 is being drawn (although such flow can be reversed, if desired, for reasons not relevant to the practice of this present invention).

As can be seen in the view of FIG. 1, the pipe 12 has straight sections 40 and bent sections 42, as will be discussed in greater detail, hereinafter. The present example of the in place pipe electrochemical polishing system 10, as shown in FIG. 1, has components not directly relevant to the explanation of the present invention, such as a pair of filters 44, a collector sump 46 and a sump pump 48 for moving the electrolyte from the collector sump 46 into the electrolyte reservoir 22.

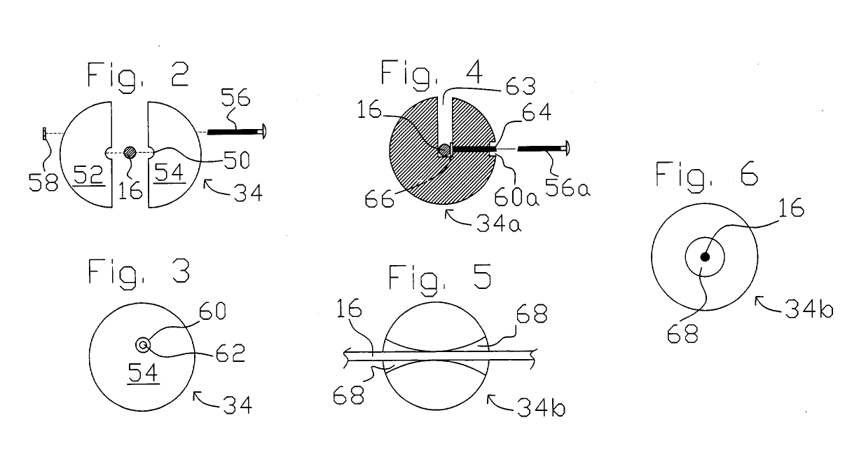

FIG. 2 is an exploded front elevational view of one example of one of the balls 34 of FIG. 1. As can be seen in the view of FIG. 2, the ball 34 grips the cable 16 generally only at a center portion 50 of the ball 34. In this example, the ball 34 is formed in a first ball half 52 and a second ball half 54, and the first ball half 52 and the second ball half 54 are recessed to accept the cable 16, as shown in the view of FIG. 2. In this example, the ball halves 52 and 54 are joined together by a screw 56 and nut 58. The screw 56 is offset from the center axis of the ball 34 such that the screw 56 does not pass through the cable 16.

In this present example of the invention, the balls 34 are machined. However, it is anticipated by the inventor that it will be more economical to mold the balls 34 when they are made in greater quantities. In the presently described embodiment of the invention, the balls 34 are made of polypropoline, although they might be made from any of a number of material types which could withstand exposure to the electrolyte 24 and the abrasion to which the balls 34 will be subjected according to the method described herein. An example of such an alternative material is Teflon™.

FIG. 3 is a side elevational view of the ball 34 of FIG. 2, showing the second ball half 54 thereof. As can be seen from this view, the ball has a recess 60 for accepting the screw 56 (FIG. 2) such that the head of the screw 56 does not project outside the general circumference of the ball 34. In applications wherein the nut 58 (FIG. 2) is used, the first ball half 52 (not shown in the view of FIG. 3) will have a similar recess for accepting the nut 58. An aperture 62 is generally positioned in the center of the recess 60 for passing the screw 56 (FIG. 2) therethrough. As discussed above in relation to FIG. 2, the aperture 62 is positioned off center on the ball half 54.

FIG. 4 is a cross sectional front elevational view of an example of another possible construction of a ball 34a. The ball 34a has a slot 63 into which the cathode puller cable 16 is introduced. An alternative screw 56a is threaded into a threaded aperture 64 in the ball 34a to hold the ball 34a in place on the cathode puller cable 16 . An optional pressure plate 66 may be used to prevent the screw 56a from damaging the cathode puller cable 16. A recess 60a prevents the screw 56a from projecting outside the limits of the ball 34a.

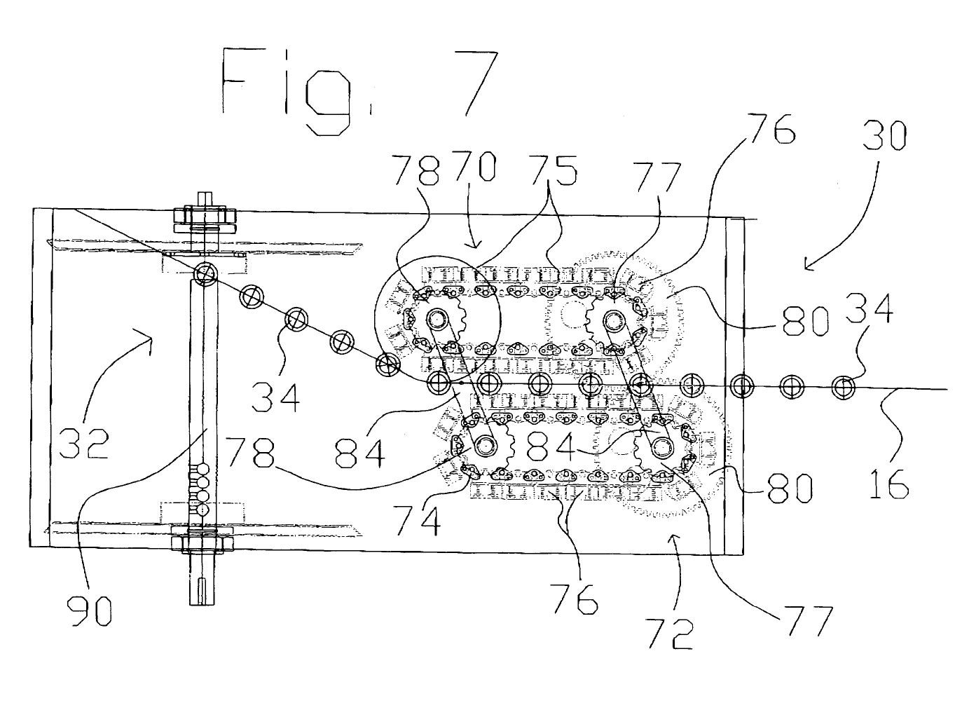

FIG. 5 is a cross sectional side elevational view of yet another example of a ball 34b. The example of FIG. 5 is of a type which has actually been used by the inventor in the practice of this present invention. The ball 34b is molded about the cable 16 such that the ball grips the cable 16 generally around the center of ball 34b. However, as can be seen in the view of FIG. 5, the ball 34b is formed such that there is a generally conical recess 68 where the cable 16 enters and exits the limits of the ball 34b. The inventor has found that providing the general conical recess 68 allows the cable 16 to bend more readily around corners, and the like, without damaging either the cable 16 or the ball 34b. As can be seen in the view of FIG. 5, the walls of the generally conical recess 68 can, optionally, be curved slightly to support the cable 16 as it might bend within the ball 34b. The exact shape of the conical recess is subject to some variation, depending upon the size and inherent stiffness of the cable 16, and the like. No particular exact shape has been determined to be superior for the practice of the invention. FIG. 6 is a front elevational view of the ball 34b of FIG. 5, showing the cable 16 in cross section. As can be seen in the view of FIG. 6, the generally conical recess 68 approximates a circle about the cable 16, as seen from this view.

The examples given are only a few of the possible constructions of balls 34, 34a and 34b which might be used to practice the present invention. A great many variations of the balls 34, 34a and 34b are possible for use with the present inventive apparatus and method. As just one example, the first ball half 52 could be threaded to accept the screw 56, thereby eliminating the need for the nut 58. Another alternative would be to use an alternative ball (not shown) which grips the cable 16 generally across the entire diameter of the ball. In such an example, it might be possible to mold such alternative balls (not shown) onto the cable 16. Yet another of the many possible variations to the ball 34 would be to use more than one screw 58, or to position the screw 56 differently than in the examples shown, or the like.

FIG. 7 is a diagrammatic top plan view of the cable puller 30 of FIG. 1. As can be seen in the view of FIG. 7, the cable puller 30 has a first tractor mechanism 70 and a second tractor mechanism 72 between which the balls 34, with the cable 16 affixed thereto, are drawn. Each tractor mechanism 70 and 72 has a linked chain 74 with a plurality of pins 75 affixed thereto. In the present embodiment of the invention the flexible pins 75 hold a plurality of traction blocks 76 which, in this example, are constructed from an acid resistant rubber material. The traction blocks 76 engage the balls 34, as can be seen in the view of FIG. 7.

The linked chains 74 are each positioned on a drive sprocket 77 and a free wheeling sprocket 78 such that the linked chain 74 is advanced between the drive sprocket 77 and the free wheeling sprocket 78. Each of the drive sprockets 77 is rigidly affixed to a driven gear 80. The two driven gears 80 are of like size, and are positioned to mesh together such that the linked chains 74 rotate in opposite directions such that the facing portions of the linked chains 74 which abut the balls 34 will move in the same direction when power is applied to the driven gears 80. A motor (omitted from the view of FIG. 7 in order to better show the inventive aspects of the invention) will be provided to power one of the driven gears. In the embodiment of the invention described herein, the motor is a pneumatic motor which drives one of the driven gears by a drive gear which engages the driven gear 80.

As can be seen in the view of FIG. 7, in the particular embodiment of the invention shown, a pair of connecting arms 84 connect the first tractor mechanism 70 to the second tractor mechanism 72. The connecting arms pivot about the axis of the drive sprockets 77 and the free wheeling sprockets 78, as shown in the view of FIG. 7. Therefore, by rotating the connecting arms 84, the distance between the first tractor mechanism 70 and the second tractor mechanism 72 can be adjusted, thereby adjusting the space between opposing traction blocks 76 to adapt the apparatus to the correct configuration for size of the particular ball 34 being used.

Also visible in the view of FIG. 7 is a diagrammatic representation of the cable take up apparatus 32 of FIG. 1. As can be seen in the view of FIG. 7, the cable take up apparatus 32 has a take up reel 90 for winding the cable 16 there about. In the embodiment of the invention described, the cable take up apparatus 32 is also powered by a pneumatic motor (not shown). Neither power means discussed herein is a necessary aspect of the invention. The cable take up apparatus 32 will generally provide tension such that the cable 16 is wound thereon as it is made available by the cable puller 30.

It should be noted that the cable puller 30 and the cable take up apparatus 32 can optionally be housed in a tub (not shown) such that any acid which spills out of the pipe 12 (FIG. 1) will be caught and contained in the tub.

In the embodiment of the invention shown in FIG. 1 and 7, the cable puller 30 is a variable speed puller. It is anticipated by the inventor that the cable puller 30 will normally operate in at least two different modes. For example, the cable 16 might be inserted into the pipe 12 at a relatively high rate, such as at about twenty five feet per minute. Then, power will be applied to the cathode 14 and the cable 16 will be extracted from the pipe 12 at a relatively slower rate, such as at about three inches per minute to perform the electropolishing operation.

Various modifications to the inventive method and apparatus are also quite possible, while remaining within the scope of the invention. For example, the quantity, construction, size, material and/or placement of the balls 34 op the cable 16 could be altered, according to the particular application.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

Industrial Applicability

Although the invention has been described herein in relation to a pipe electropolishing apparatus, it should be noted that the invention has application in essentially any situation wherein a cable, wire, tape, or the like is to be pulled through a pipe, conduit, or the like.

In the presently described embodiment of the invention, it should be noted that the interior of the cable puller 30 mechanism will be exposed to the acid electrolyte 24 and should, therefore, be constructed of acid resistant materials. However, it is within the scope of the invention that a means might be devised to prevent the flow of acid into the cable puller 30, thereby rendering such materials unnecessary. Optionally, and in some applications, it may be necessary to provide an additional fluid reservoir (not shown) to collect whatever electrolyte 24 might leak from the cable puller 30.

It should be noted that the balls 34, 34a and 34b of the present invention act somewhat like a dam to partially restrict the flow of the electrolyte 24 in the pipe. However, the balls 34, 34a and 34b do not provide a perfect seal within the pipe, nor should they, since it is desirable to allow the electrolyte 24 to flow through the pipe 12, as previously discussed herein.

According to the present invention, the cathode 14 can be pushed through the pipe 12 by the cable 16 prior to beginning a polishing operation. This avoids the prior art necessity of pulling the cable through the pipe 12 by a guide wire, tape, or the like. Since this preliminary step has been one of the most time consuming and tedious operations in the prior art, a great savings in time, effort, and money is realized according to the present invention. After the cathode 14 is full inserted into the pipe 12, then power is applied to the cathode 14 from the power supply 36 to begin the polishing operation, and the direction of the cable puller 30 is reversed and slowed, as discussed previously herein, to pull the cathode 14 through the pipe 12 as the polishing operation progresses. Without the balls 34, 34a or 34b affixed to the cable 16, the cable 16 would either not be sufficiently stiff to push the cathode 14 through the pipe 12, or else it would be too rigid to bend well around corners and bends in the pipe 12.

Yet another aspect of the present invention not yet fully discussed stems from the fact that the ability of the cable 16 to be moved in both directions through the pipe 12 provides yet another advantage. The inventor has discovered that some portions of the pipe 12, such as bent portions thereof, may require more polishing than other sections of the pipe 12. The present inventor has addressed this previously by means such as slowing the progress of the cathode 14 in bent sections of the pipe 12 and/or increasing the voltage to the cathode 14 when the cathode 14 is in bent portions of the pipe 12. However, according to the present invention, this problem can be solved by selectively reversing the direction of the cathode 14 after the cathode 14 has passed through a bent portion such that the cathode 14 passes through the bent portion two or more times, thereby providing the additional polishing action desired in such bent portion.

The inventive pipe electrochemical polishing system 10 and associated cable 16, balls 34, 34a, 34b and cable puller 30 are intended to be widely used for the in place polishing of the interior of piping systems. Further the inventive cable 16, balls 34, 34a, 34b, cable puller 30 and associated equipment are intended to be widely used wherever a cable, wire, tape, or the like, is required to be pulled through a pipe, conduit, channel, or the like. Since the inventive pipe electrochemical polishing system 10 and associated in place electropolishing method may be readily produced and integrated with existing electropolishing systems, and since the advantages as described herein are provided, it is expected that it will be readily accepted in the industry. For these and other reasons, it is expected that the utility and industrial applicability of the invention will be both significant in scope and long-lasting in duration.

I claim:

1. A cable support apparatus for pulling a cable through a pipe, comprising:
a cable; and
a plurality of balls affixed to said cable and distributed along at least a portion thereof.

2. The cable support apparatus of claim 1, and further including:
a pulling apparatus for pulling said cable with said balls affixed thereto.

3. The cable support apparatus of claim 2, wherein:
the pulling apparatus includes a tractor mechanism for pulling said balls therethrough.

4. The cable support apparatus of claim 3, wherein:
the tractor mechanism includes a link chain moving between at least two sprockets.

5. The cable support apparatus of claim 3, wherein:
the tractor mechanism includes two opposed link chains.

6. The cable support apparatus of claim 3, wherein:
the link chain has affixed thereto a plurality of tractor blocks for contacting said balls.

7. The cable support apparatus of claim 2, and further including:
a take up reel for coiling said cable as said cable is pulled through the pulling apparatus.

8. A ball for supporting a cable, comprising:
a first ball portion; and
a second ball portion, wherein;
the cable is clamped between said first ball portion and said second ball portion.

9. The ball of claim 8, and further including:
a center recessed portion on at least one of said first ball half and said second ball half, such that, when said first ball half is joined to said second ball half, the cable is clamped in the center recessed portion.

10. The ball of claim 8, and further including:
a fastener for connecting said first ball half to said second ball half.

11. The ball of claim 10, wherein:
the fastener includes a screw.

12. The ball of claim 8, wherein:
the first ball portion and the second ball portion are molded as a single unit about the cable.

13. The ball of claim 8, wherein:
the ball includes a generally conical recess; and
the cable passes through the generally conical recess.

14. An in place electropolishing apparatus for polishing a pipe, comprising:
an electrode;
a cable for pulling said electrode through the pipe; and
a plurality of balls affixed to said cable such that said cable is generally spaced away from the walls of the pipe by said balls.

15. The in place electropolishing apparatus of claim 14, and further including:
an electrolyte source; and
a pump for pumping the electrolyte through the pipe.

16. The in place electropolishing apparatus of claim 14, wherein:
the electrode is a cathode.

17. The in place electropolishing apparatus of claim 14, and further including:
a power supply for providing power to said electrode.

18. The in place electropolishing apparatus of claim 14, and further including:
a cable puller for pulling the cable with the balls affixed thereto through the pipe.

19. The in place electropolishing apparatus of claim 18, and further including:
a take up reel for taking up slack cable from the cable puller.

20. A method for pulling an object through a pipe, comprising:
(a) affixing the object to a cable;
(b) affixing a plurality of balls dispersed along the length of the cable; and
(c) pulling the object through the pipe by the cable.

21. The method of claim 20, wherein:
the object is a cathode for an in place pipe electropolishing system.

22. The method of claim 20, and further including:
after step (b) and preceding step (c), the operation of pushing the object through the pipe using the cable.
